(19) United States
(12) Patent Application Publication
(10) Pub. No.: US 2005/0008290 A1
(43) Pub. Date: Jan. 13, 2005

(54) Static method for laser speckle reduction and apparatus for reducing speckle

(76) Inventor: Nicolae Miron, Pierrefonds (CA)

Correspondence Address: SEYFARTH SHAW, 55 EAST MONROE STREET, SUITE 4200, CHICAGO, IL, 60603-5803, US

(21) Appl. No.: 10/847,070

(22) Filed: May 17, 2004

Related U.S. Application Data
(60) Provisional application No. 60/470,805, filed on May 15, 2003.

(51) Int. Cl. G02B 6/26

(52) U.S. Cl. 385/27

(57) ABSTRACT

An apparatus and method is disclosed for reducing speckle of a laser beam, the apparatus comprising at least one beam-collimating element having an input and an output, at least one birefringent optical coupler having a first and a second inputs, and a first and a second outputs, at least one optical feedback element having an input and an output, the input of the at least one optical feedback element being connected to the second output of the at least one birefringent optical coupler and the output of the at least one optical feedback element being connected to the second input of the at least one birefringent optical coupler, an optical fiber connecting the output of the at least one beam-collimating element to the first input of the at least one birefringent optical coupler, an optical focusing element having an input and an output, and an optical fiber connecting the first output of the at least one birefringent optical coupler to the input of said optical focusing element, wherein said laser beam is provided to said input of said at least one beam-collimating element resulting in said laser beam having reduced speckle at said output of said optical focusing element.

This invention relates to illumination of objects suitable for machine vision applications. More particularly, it relates to a laser speckle reduction method an apparatus for reducing speckle.

Some applications in machine vision require that a structured laser beam be projected on a target. The structured laser beam can be, for instance, a line, a pattern of lines or a pattern of dots. Beams generated by lasers advantageously have a narrow bandwidth (about 5 nm). Narrow band pass optical filters centered on the laser beam wavelength can be used to remove most of the ambient light, thereby increasing the sensitivity of machine vision systems. However, laser beams are also coherent and produce a coherent optical noise pattern on a target. This optical noise is generally known as speckle. Speckle appears as a local interference between the beams scattered by a rough surface and reduces the spatial resolution of machine vision systems.

Certain applications require low optical noise when using laser beams to illuminate a target. However, most of the conventional speckle reduction approaches are based on changes of the phase shift between the interfering beams, associated with a time averaging of the speckle pattern. These approaches are thus not suitable for high-speed machine vision systems. For instance, speckle reduction by time averaging of the phase shift is described in U.S. Pat. No. 4,035,068. In this patent, a rotating diffuser is positioned between the light source and the target. This approach significantly reduces the speckle in projected images as seen by the human eye and perceived by the human brain since they both integrate the fast changes in the speckle pattern produced by the moving diffuser.

Another speckle reduction method is described in U.S. Pat. No. 6,323,984. In this patent, a wavefront modulator changes the spherical wavefront incident on it. At the output, the wavefront is no longer spherical, but it is still spatially coherent, with well-defined phase relationships between the different points of the wavefront. It will not, however, reduce the speckle unless it is vibrated across a direction perpendicular to the incident beam. This also produces a speckle reduction on the target by time averaging.

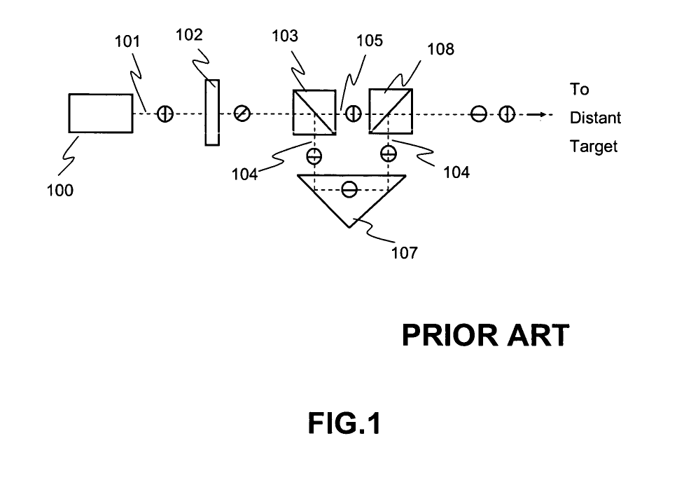

Another approach is disclosed in U.S. Pat. No. 4,511,220. In this system, shown in FIG. 1, the changes in state of polarization (SOP) allow a reduction in the speckle. Linear polarized beam 101 from the laser 100 is rotated by the polarization rotator 102, and it is sent further to an optical device 103 that outputs two beams 104 and 105 having orthogonal polarizations. Optical elements 107 and 108 overlap the beams 104 and 105 in the same direction toward the target. Therefore, the target is illuminated with two beams with two orthogonal polarizations, and the speckle is reduced compared to the case where the target is illuminated with a linear polarized beam. The reason is that there are two overlapped speckle patterns with two orthogonal polarizations, appearing as a pattern with less speckle. The speckle is reduced instantly since there is no time averaging.

Another non-averaging approach for reducing the speckle is described in U.S. Pat. No. 6,169,634. In this system, a plurality of optical fibers of various lengths introduces different phase retardations of the incident wavefront. The phase relationships between the wavefront points are different between the output and the input, but the phase shifts between different points on the wavefront still remain constant within the coherent length of the laser beam. There is thus no significant speckle reduction with this approach.

Speckle reduction for pulsed light beams is described in U.S. Pat. No. 6,191,887. The initial pulse of coherent radiation is divided into successions of pulslets, temporally separated and with spatial aberrations. Spatial aberrations induce changes in the wavefront, and temporal separations induce changes in temporal coherence. The output pulse will have different wavefront and shape than that of the input pulse, but it will be still spatially coherent. Speckle reduction is not significant with this approach.

Laser speckle could be reduced for certain applications by linear scan of a laser beam with a small angle (in the order of a few degrees) using a scanning galvanometer, as described in U.S. Pat. No. 5,621,529. Speckle is reduced by integrating the position of dots during multiple frames of a TV camera that takes image of the target. This results in the line pattern appearing with less speckle. Again, this is not always appropriate for high-speed machine vision systems.

In general terms, the present invention provides a method and appropriate apparatus for speckle reduction to generate a low speckle laser beam. The method consists in decreasing the speckle by decreasing the interference contrast upon increasing the number of polarization states of the laser beam. The speckle reduction apparatus according to one aspect of the present invention comprises a laser beam source for launching the laser beam into the core of an optical fiber, optical element to generate a multitude of polarization states, either from a single polarization state or from a few polarization states of the input laser beam, and transmission element having an output for delivering a diversity of beam geometries. The laser beam source for launching the laser beam into the optical fiber core preferably comprise a laser beam collimator, a fiber optic collimator, or a combination of both. The optical elements for increasing the number of polarization states of the laser beam preferably comprise fiber optic couplers with appropriate optical feedback. The transmission element for delivering the output beam preferably comprise a lens to collimate the laser beam delivered at optical fiber output or to focus the beam, and optionally some optical elements to generate structured light pattern such as lines, dots and circles.

In use of one embodiment, the beam generated by the laser source is collimated and then launched into the core of an optical fiber. The light can propagate into the fiber either in single mode or in multimode. Single mode propagation keeps the same polarization state of the incident beam. In multimode propagation, each mode has its own polarization state, and therefore multiple polarization states are generated just at the entrance into the fiber. Further, the light preferably goes at one input of a 2×2 fused coupler. The other input of this coupler is connected to one of the outputs of the same coupler to provide a local optical feedback per coupler. The feedback loop may also contain one or many birefringent elements. Because fused couplers are also birefringent elements, output beams will have more polarization states than the input beam. The optical feedback re-circulates a part of the output beam through the coupler, adding even more polarization states each time the beam goes through the coupler. Cascaded couplers introduce more polarization states than a single coupler. At the output, a lens collects the beam and generates either a focused beam, a diverging beam or a collimated beam. The beam delivered by the output collimator can also go through some additional optical elements to generate a line, a pattern of lines, a circle, a pattern of circles, or a pattern of dots or other beam patterns required by the application. All these beam patterns have less speckle than that of similar patterns obtained when pattern-generating elements receive a laser beam directly from the laser source.

One advantage of the present invention is that the speckle reduction is induced instantly, i.e. without time averaging. The propagation through optical feedback introduces some small delay, but this happens only when the laser beam initially enters into the fiber. Later, this delay is invisible and multiple polarization states appear instantly to the user.

An embodiments of the invention will now be described by way of example only with reference to the accompanying drawings in which:

FIG. 1 is a schematic view of an optical setup that generates two polarization states at the output from one polarization state at the input, as shown in U.S. Pat. No. 4,511,220.

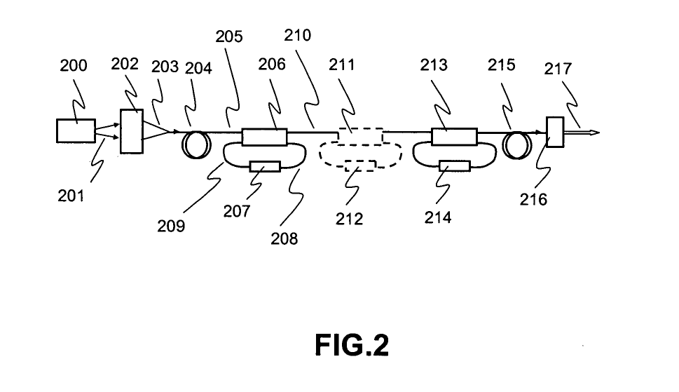

FIG. 2 is a schematic view of an example of a speckle reduction apparatus with feedback loops.

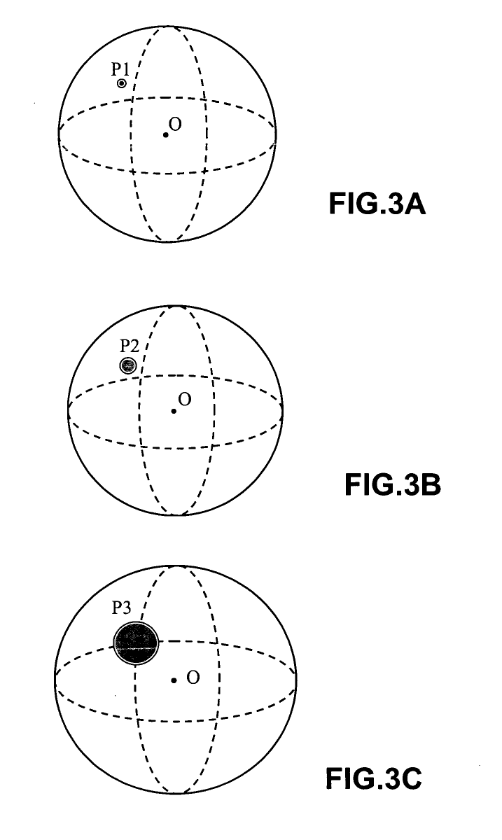

FIG. 3A is a schematic view of the Poincaré sphere, showing the typical polarization states of the laser beam at the input.

FIG. 3B is a schematic view of the Poincaré sphere showing the polarization states of the beam at the output of the first coupler.

FIG. 3C is a schematic view of the Poincaré sphere showing the polarization states of the beam at the output of the cascaded couplers.

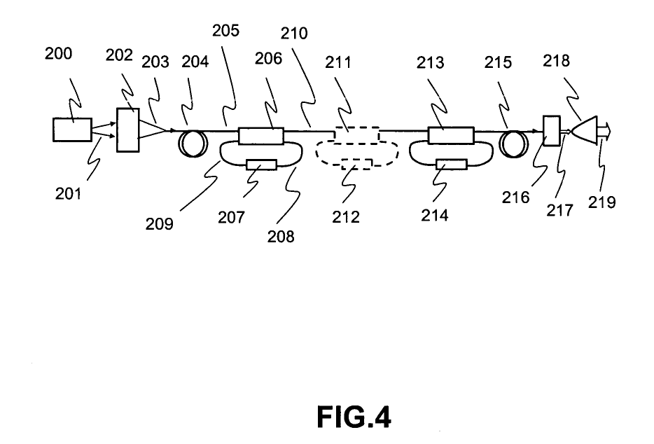

FIG. 4 is a schematic view of another possible embodiment of the speckle reduction apparatus, showing an apparatus that generates a line at the output.

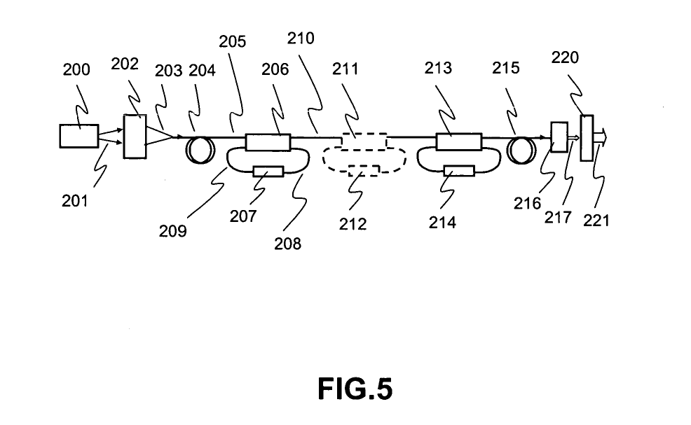

FIG. 5 is a schematic view of another possible embodiment of the speckle reduction apparatus, showing an apparatus that generates a structured light pattern at the output.

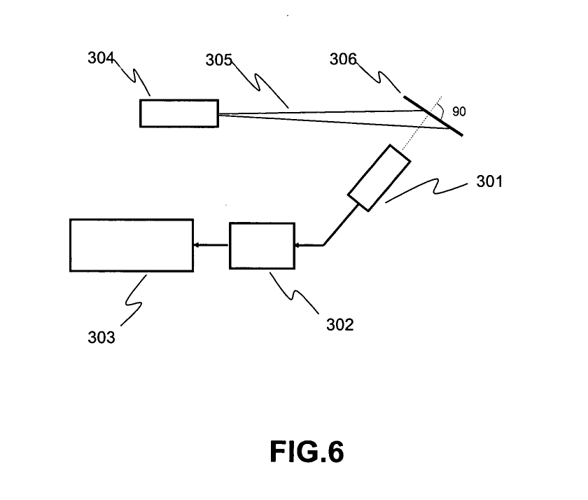

FIG. 6 is a schematic view of an apparatus to evaluate the speckle.

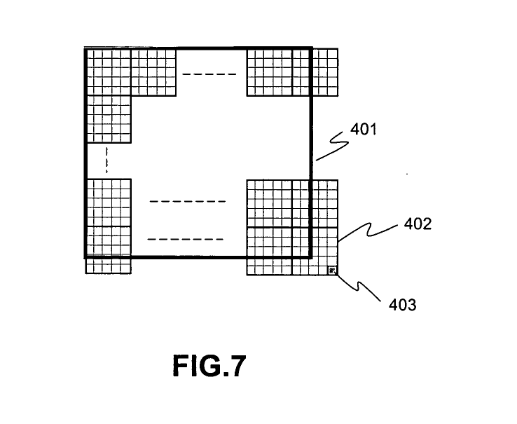

FIG. 7 shows an example of the partition of an area selected for speckle evaluation.

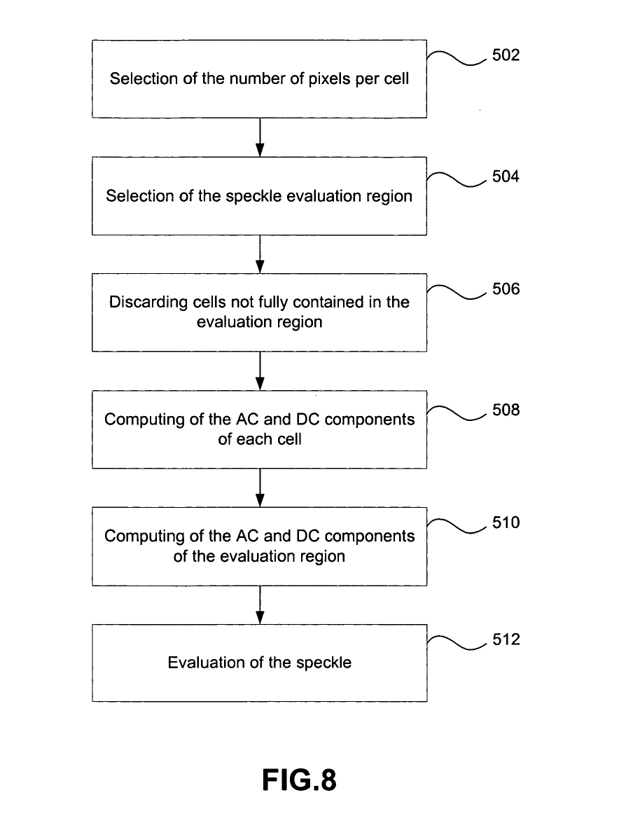

FIG. 8 is a flow diagram of the laser speckle evaluation algorithm.

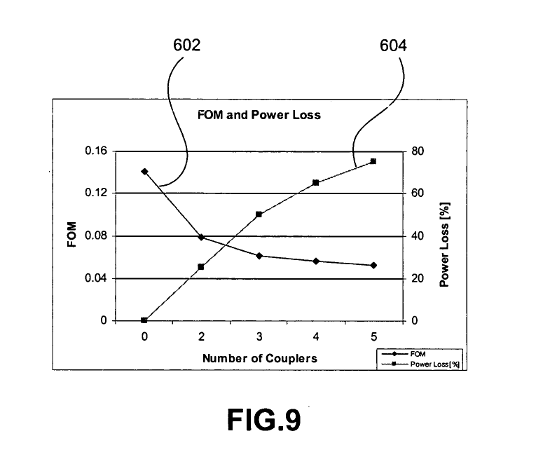

FIG. 9 shows a graph of an evaluation of laser speckle and power loss as a function of the number of coupler used in the speckle reduction apparatus of FIG. 2.

The preferred embodiment of the apparatus for laser speckle reduction with fiber optic non-averaging depolarizer is shown in FIG. 2. The practical implementation of the present invention may differ from application to application, but the basic principles will remain the same.

In FIG. 2, laser source 200 generates a beam 201 with very few polarization states, such as linear or elliptical. When visualized using an instrument, such as the HP 8509B Lightwave Polarization Analyser, the polarization states of the beam 201 typically appear as a small region P1 on the Poincaré sphere, as shown in FIG. 3A. The beam 201 is further collimated by one or multiple optical elements such as lenses and prisms, collectively denominated as beam collimating element 202 in FIG. 2. The beam 203 at the output of the beam-collimating element 202 is sent into the optical fiber 204, where the beam propagates either in single mode regime, or in multimode regime. In single mode propagation, the beam 203 keeps the same polarization states as generated by the laser source 200. In multimode propagation, each mode has its own polarization state, and the beam 203 increases its number of polarization states as it propagates into the fiber 204. The beam 203 is sent at the input 205 of a 2×2 fiber optic fused coupler 206 with optical feedback element 207. This fused coupler 206 is birefringent. The split point introduces an asymmetry in the fiber core, generating additional polarization states at the output 210 of the coupler 206. The number of polarization states at the output 210 is thus increased by routing the output 208 to the input 209 via the optical feedback element 207. The element 207 can be a birefringent crystal, a polarization-maintaining optical fiber, a segment of polarization-maintaining optical fiber, a segment of multi-mode optical fiber, or any optical component that introduces additional polarization states to the input beam. Routing the output 208 to the input 209 with a segment of single-mode optical fiber will also induce more depolarization of the beam at the output 210. The components of the feedback loop 208, 207 and 209 will route an infinite number of times a fraction of the beam available at the input 205.

The number of polarization states added to the input beam 203 is somehow limited because of the limited birefringence behaviour of the coupler 206 and also of the feedback element 207. However, the beam at the output 210 has a larger region P2 of polarization states on the Poincaré sphere, as shown in FIG. 3B. An appropriate selection of coupler type, coupler split ratio and the optical feedback element maximizes the number of additional polarization states added to the input beam 203. More polarization states of the beam produce an interference pattern with less contrast or an image with less speckle.

The optical feedback from the output 208 to the input 209 will also change the wavefront of the beam at the output 210 with respect to the input beam 205. This change of the waveform has a little effect on the speckle, because the beam still has a high spatial coherence at the output 210. Beam intensity at the output 210 is lower than that at the input 205, partly because some of the input beam remains trapped into the feedback loop.

More polarization states are added to the beam by cascading more birefringent elements with feedback loops, such as the coupler 211 with its feedback element 212 and the coupler 213 with its feedback element 214. The number of polarization states added to the beam further increase the dimension of the region on the Poincaré sphere, such as P3 in FIG. 3C, which may eventually cover the entire Poincaré sphere. A laser beam with a larger region on the Poincaré sphere produces less speckle. The number of cascaded couplers depends on the extent of speckle reduction required for a particular application and also on the initial polarization of the laser beam 203. Less polarized laser beam requires less polarization states to be added for reducing the speckle.

In the preferred embodiment of this invention, the output optical fiber 215 of the last coupler 213 of the cascade sends the beam to an optical focusing element, such as a lens, 216 that delivers an output beam 217. The beam 217 may be made either collimated, diverging or it may also be focused on a target.

Another embodiment of the present invention is shown in FIG. 4. In this embodiment, the output beam 217 goes through a Powell lens 218. The beam 219 at the output of the Powell lens 218 generates a low speckle line on the target.

A further embodiment is shown in FIG. 5. In this embodiment, the output beam 217 goes through a diffractive optical element 220 that generates the beam 221. The beam 221 can produce a low speckle pattern of lines, dots, circles or other custom patterns depending on the phase transform introduced by the diffractive element 220.

The method for laser speckle reduction and the corresponding apparatus hereby disclosed provides a number of advantages compared to existing ones. The method reduces the speckle by generating a multitude of polarization states of the laser beam starting from a laser beam with only a few polarization states, without any change in time of initial polarization states, or without time averaging. The speckle reduction method is based only on electrically passive components. Therefore, it does not require any power supply. The speckle is reduced into a broad wavelength range by using the same optical components that do not require any wavelength dependent adjustments. Speckle can be reduced with a controllable amount as required by the polarization of the beam generated by the laser and also by the application.

Speckle reduction is generally associated with a certain criterion to evaluate the speckle content. Traditionally, speckle was evaluated by measuring the contrast of the interference pattern. One can refer to the following references: “Goodman, J., W., Statistical Properties of Laser Speckle Patterns, Topics in Applied Physics, vol. 9, 1984, pp.9-75, Editor: J. C. Dainty” and more recently “Wang, L., et al., Speckle Reduction in Laser Projection Systems by Diffractive Optical Elements, Applied Optics, vol. 37, No. 10, pp. 1770-1775 (Apr. 1, 1998)”. According to these references, speckle contrast C_{G} is expressed as:
C_{G}=σ₁/<I> Equation 1
where σ₁, is the standard deviation of the intensity, and <I> is its mean value. The traditional evaluation method treats the speckle as optical noise and uses the root mean square of signal-to-noise ratio (S/N)ᵣₘₛ to evaluate the speckle, such as:

$${( \frac{S}{N} )}_{rms} = \frac{\text{<} I \text{>}}{{σ}_{I}} \qquad Equation 2$$

Equation 2 is the reciprocal of Equation 1. The contrast is also the measure that evaluates the speckle in Equation 2. Speckle evaluation by calculating the contrast consists of measuring the beam intensity into a large number of points of a selected area, followed by computing the average <I>, standard deviation σ₁, and finally the contrast C_{G}. This is computationally intensive and for the same speckle content, the contrast value depends strongly on the size of the selected region.

The present invention provides a new method for speckle evaluation and an apparatus that evaluates the speckle by using this method. Preferably, the method for speckle evaluation considers the speckle content of a selected region as a noise superimposed on the pure or speckle-free optical signal, and then evaluating the speckle with a Figure of Merit (FOM) defined as the ratio between the speckle content and the speckle-free optical signal content.

As shown in FIG. 6, the evaluation apparatus preferably comprises an image acquisition device 301 for example a digital camera such as a Pulnix™ model 1010, connected to an image acquisition system 302, such as National Instruments' 16-bit frame grabber PCI-1442, and a computer 303. In a particular embodiment, the setup is to have a laser 304 under evaluation projecting its beam 305 on a target 306. Any image or light pattern produced by a laser beam could be projected upon the target 306. Using an image acquisition software, such as IMAQ™ provided by National Instruments, running on the computer 303 and the image acquisition system 302, the image acquired by the image acquisition device 301 is stored in the computer 303. The image may also be displayed on the computer's 303 display. According to this method, speckle is evaluated across a selected region 401 of the displayed image. The selected region 401 is divided in square cells 402 with user-selectable number of pixels 403 such as 5×5 pixels, as shown in FIG. 7. Cells array 402 makes a two-dimensional sampling of the selected region 401. Each pixel 403 preferably corresponds to a pixel of a TV frame.

The algorithm to obtain the speckle evaluation is depicted by the flow chart shown in FIG. 8. The sequence of steps composing the algorithm is indicated by the sequence of blocks 502 to 512. At block 502 the algorithm sets the number of pixels per cell, this number may be users-selectable. Smaller cells, such as 3×3 pixels, have poor statistics but may provide a better local intensity profile and could be used for FOM evaluation across smaller regions. Cells with larger number of pixels, such as 8×8, provide better statistics but they may not adequately follow rapid local changes in intensity. The 5×5 pixel cell size was found to be a good compromise for a large class of applications.

At block 504, the speckle evaluation region 401 is selected and, at block 506, cells not fully contained inside the selected region 401 are discarded. At block 508, the AC and DC components of each cell are computed. The AC component is computed by estimating fast changes in pixel intensity, coming from the speckle-only component of the optical signal, and the DC component is computed by estimating slow changes in pixel intensity, coming from the speckle-free component of the optical signal. This may be achieved, for instance, by using the “AC and DC Estimator” function built within LabVIEW™ 6.i. applied to the intensity of the pixels composing each cell. Then, at block 510, the AC and DC components of the selected region 401 are computed by computing the mean of the AC and DC components of all the cells, respectively.

Finally, at block 512, the speckle content is preferably estimated as FOM, more particularly as the ratio between the total power of the AC component and the total power of the DC component computed at block 510, such as depicted by the following equation:

$$FOM = \frac{Total\_Power \_of \_AC \_Component}{Total\_Power \_of \_DC \_Component} \qquad Equation 3$$

As may be appreciated, other functions similar to the AC and DC estimators may be used as well, which separate the speckle-only component as high frequency spectral part of the image, and speckle-free component as a low frequency spectral part of the image.

Referring back to FIG. 2, the FOM 602 depends on the number of couplers 206 used in the speckle reduction apparatus, as illustrated by the example of FIG. 9. Each coupler 206 also introduces a power loss 604. As may be seen in FIG. 9, two couplers 206, such as, for example, 22-10678-4521201 couplers from Gould Fiber Optics, produce the most significant decrease in FOM 602 with the lowest power loss 604. The third coupler 206 decreases significantly the FOM 602 but adds more power loss 604. More than three couplers 206 have less impact on FOM 602, but induce large power loss 604. Thus there is an application dependent tradeoff between the number of couplers 206 and the power loss 604. Of course, depending on the coupler and components used, speckle and power loss values may vary from those illustrated in FIG. 9, which is given for purpose of example only.

The present method for evaluating the speckle with FOM provides a number of advantages over traditional methods. This method allows to evaluate the speckle by using a function to separate speckle-only component and speckle-free component from the distribution of pixel intensities across a selected area of an image by computing power contained in each component and expressing the speckle content as the ratio of these power values. This makes the method less insensitive to the size of the selected region and also to the laser beam power.

Although the present invention has been described by way of a particular embodiment thereof, it should be noted that modifications may be applied to the present particular embodiment without departing from the scope of the present invention and remain within the scope of the appended claims.

1. An apparatus for reducing speckle of a laser beam comprising:
at least one beam-collimating element having an input and an output;
at least one birefringent optical coupler having a first and a second inputs, and a first and a second outputs;
at least one optical feedback element having an input and an output, said input of said at least one optical feedback element being connected to said second output of said at least one birefringent optical coupler and said output of said at least one optical feedback element being connected to said second input of said at least one birefringent optical coupler;
an optical fiber connecting said output of said at least one beam-collimating element to said first input of said at least one birefringent optical coupler;
an optical focusing element having an input and an output; and
an optical fiber connecting said first output of said at least one birefringent optical coupler to said input of said optical focusing element;
wherein said laser beam is provided to said input of said at least one beam-collimating element resulting in said laser beam having reduced speckle at said output of said optical focusing element.

2. A speckle reducing apparatus according to claim 1 wherein said optical focusing element is a lens.

3. A speckle reducing apparatus according to claim 1 further comprising a Powell lens connected to said output of said optical focusing element.

4. A speckle reducing apparatus according to claim 1 further comprising a diffractive optical element connected to said output of said optical focusing element.

5. A speckle reducing apparatus according to claim 1 wherein said at least one beam-collimating element is a lens.

6. A speckle reducing apparatus according to claim 1 wherein said at least one beam-collimating element is a prism.

7. A speckle reducing apparatus according to claim 1 wherein said at least one optical feedback element is a birefringent crystal.

8. A speckle reducing apparatus according to claim 1 wherein said at least one optical feedback element is a polarization-maintaining fiber.

9. A speckle reducing apparatus according to claim 1 wherein said at least one optical feedback element is a multimode fiber.

10. A speckle reducing apparatus according to claim 1 wherein said optical fiber connecting said output of said at least one beam-collimating element to said first input of said at least one birefringent optical coupler is a single-mode optical fiber.

11. A speckle reducing apparatus according to claim 1 wherein said optical fiber connecting said output of said at least one beam-collimating element to said first input of said at least one birefringent optical coupler is a multimode optical fiber.

12. A method of reducing speckle of a laser beam comprising the steps of:
providing a laser beam to at least one beam-collimating element having an input and an output;
directing said output of the beam-collimating element to an optical fiber connecting said output of said at least one beam-collimating element to a first input at least one birefringent optical coupler having a second input, and a first and a second outputs;
directing said second output of said at least one birefringent optical coupler to said second input of said at least one birefringent optical coupler; and
directing said first output of said at least one birefringent optical coupler to an optical fiber connecting said first output of said at least one birefringent optical coupler to an input of an optical focusing element having an output;
wherein output of said optical focusing element provides in a laser beam having reduced speckle.

13. A method of evaluating speckle in a laser beam comprising the steps of:
obtaining image data from the laser beam;
selecting a region of the image data;
dividing the selected region in cells, each cell being a two dimensional array of pixels;
discarding cells not fully contained within the selected region;
computing a high frequency spectral component of the cells by estimating fast changes in the pixel intensity of the cells;
computing a low frequency spectral component of the cells by estimating low changes in the pixel intensity within the cells;
computing a mean of the high frequency spectral component of the cells;
computing a mean of the low frequency spectral component of the cells; and
computing a ratio of the mean of the high frequency spectral component of the cells to the mean of the low frequency spectral component of the cells, the ratio being indicative of the level of speckle the laser beam.

14. A speckle evaluation method according to claim 13 wherein the dimension of the pixel array is user selectable.

15. A speckle evaluation method according to claim 13 wherein the dimension of the pixel array is 5×5.

16. A speckle evaluation method according to claim 13 wherein the dimension of the pixel array is 3×3.

17. A speckle evaluation method according to claim 13 wherein the dimension of the pixel array is 8×8.

18. A speckle evaluation method according to claim 13 wherein the steps of computing the high frequency component and the low frequency component are done using the AC and DC Estimator function of LabVIEW™.

19. An apparatus for the evaluation of speckle in a laser beam comprising:
an image acquisition device;
an image acquisition system operative with said image acquisition device to obtain image data from the reflection of the laser beam unto a surface;
a processor;
a memory;
an image acquisition software to be run on the processor, the image acquisition software being operative with the image acquisition system to store the image data unto the memory; and
a program comprising the steps of claim 0 to be run by the processor on the image data stored in the memory;
wherein the execution of the program by the processor provides an evaluation of the speckle in the laser beam.

20. A speckle evaluation apparatus according to claim 19 wherein the image acquisition device is a digital camera.

21. A speckle evaluation apparatus according to claim 20 wherein the digital camera is a Pulnix™ model 1010.

22. A speckle evaluation apparatus according to claim 19 wherein the image acquisition system is a National Instruments' 16-bit frame grabber PCI-1442.

23. A speckle evaluation apparatus according to claim 19 wherein the image acquisition software is the IMAQ™.
